(19) United States
(12) Patent Application Publication
(10) Pub. No.: US 2026/0299638 A1
(43) Pub. Date: Oct. 1, 2026

(54) ARCHITECTURE AND SYSTEM OF FULLY RECONFIGURABLE UNIVERSAL INTELLIGENT LIGHT COMPUTING CHIP

(71) Applicant: TSINGHUA UNIVERSITY, BEIJING (CN)

(72) Inventors: LU FANG, BEIJING (CN); YIZHOU JIANG, BEIJING (CN); SHANGLONG LI, BEIJING (CN); TIANKUANG ZHOU, BEIJING (CN)

(21) Appl. No.: 19/630,392

(22) Filed: Mar. 26, 2026

(30) Foreign Application Priority Data
Mar. 28, 2025 (CN) 2025103797358

(51) Int. Cl. G06E 1/00

(52) U.S. Cl. CPC G06E 1/00

(57) ABSTRACT

An architecture of a fully reconfigurable universal intelligent light computing chip, includes: an emitting module, configured to obtain and emit at least one set of single-wavelength beam-split lights by splitting each first single-wavelength light in a first broadband light corresponding to a target task into beams, in which there is a one-to-one correspondence between the first single-wavelength light and the set of single-wavelength beam-split lights; and a receiving module, configured to receive the at least one set of single-wavelength beam-split lights, and perform a matrix calculation on the at least one set of single-wavelength beam-split lights based on an optical propagation matrix corresponding to the target task to obtain a second broadband light subjected to optical computation.

### CROSS-REFERENCE TO RELATED PATENT APPLICATION

The present application is based upon and claims priority to Chinese Patent Application No. 2025103797358, filed on Mar. 28, 2025, the entirety contents of which are incorporated herein by reference.

### FIELD OF THE DISCLOSURE

The present disclosure relates to a field of light computing technology, and specifically to an architecture and a system of a fully reconfigurable universal intelligent light computing chip.

### BACKGROUND OF THE DISCLOSURE

With a rapid development in fields of artificial intelligence and scientific computing, a complexity and scale of computing demands are constantly increasing. However, the existing electronic computing technology is constrained by Moore's Law, and its performance is gradually approaching a saturation state, making it difficult to effectively meet increasingly strict requirements for computing power and energy consumption posed by a large-scale complex algorithm. Light has natural advantages such as a high throughput and a low latency in its propagation process. Light computing technology, which uses a photon instead of an electron as a computing carrier, is regarded as a key to breaking through an existing computing bottleneck.

### SUMMARY OF THE DISCLOSURE

A first aspect of the embodiments of the present disclosure proposes an architecture of a fully reconfigurable universal intelligent light computing chip, including:
an emitting module, configured to obtain and emit at least one set of single-wavelength beam-split lights by splitting each first single-wavelength light in a first broadband light corresponding to a target task into beams, in which there is a one-to-one correspondence between the first single-wavelength light and the set of single-wavelength beam-split lights; and
a receiving module, configured to receive the at least one set of single-wavelength beam-split lights, and perform a matrix calculation on the at least one set of single-wavelength beam-split lights based on an optical propagation matrix corresponding to the target task to obtain a second broadband light subjected to optical computation, in which the second broadband light includes at least one second single-wavelength light, there is a one-to-one correspondence between the second single-wavelength light and the first single-wavelength light, there is a one-to-one correspondence between the set of single-wavelength beam-split lights and a row in the optical propagation matrix, and there is a one-to-one correspondence between a single-wavelength beam-split light in the set of single-wavelength beam-split lights and a row element in the row.

A second aspect of the present disclosure proposes a system of a fully reconfigurable universal intelligent light computing chip, including: an architecture of at least one fully reconfigurable universal intelligent light computing chip of any one of the first aspect above.

### BRIEF DESCRIPTION OF THE DRAWINGS

The above and/or other aspects and advantages of embodiments of the present disclosure will become apparent and more readily appreciated from the following descriptions made with reference to the accompanying drawings.

FIG. 1 is a block diagram of an architecture of a fully reconfigurable universal intelligent light computing chip according to the embodiments of the present disclosure.

FIG. 2 is a schematic diagram of a principle of an architecture of a fully reconfigurable universal intelligent light computing chip according to the embodiments of the present disclosure.

FIG. 3 is a schematic diagram of a simulation result of an architecture of a fully reconfigurable universal intelligent light computing chip according to the embodiments of the present disclosure.

### DETAILED DESCRIPTION OF THE EXEMPLARY EMBODIMENTS

The embodiments of the present disclosure are described in detail below. Examples of the embodiments are shown in the accompanying drawings, in which the same or similar labels throughout the embodiments represent the same or similar elements or elements having the same or similar functions. The embodiments below with reference to the accompanying drawings are exemplary and are intended to explain the present disclosure, but should not be construed as a limitation to the present disclosure.

With a rapid development of artificial intelligence technology, especially in breakthroughs of a large model (such as a large language model, a video generation model, etc.), a computing demand is growing exponentially. A scale of the large model has gradually expanded from few million parameters initially to hundreds of billions or even trillions of parameters currently. These models have shown great potential in natural language processing, computer vision, autonomous driving, and other fields. However, training and inference of such large-scale models pose unprecedented challenges to a computing power. A bottleneck of a traditional electronic computing architecture lies in its high power consumption and limited computing speed, which may not fully meet an increasing demand for computing of a large-scale artificial intelligence model.

In addition, a current light computing architecture faces a contradiction where it is impossible to achieve both a computing scale and a reconfigurable capability; at the same time, a designed and determined light chip has a fixed computing mode and do not have a capability of a reconfigurable computing mode; besides, light chip computing may not achieve an arbitrary matrix in a single-layer propagation situation and usually requires a plurality of layers of multiplexing to complete. These limitations make light computing unable to meet a current demand for reconfigurable, large-scale integrated computing of the large model and fail to fully develop a potential of light computing.

Therefore, how to make a light computing chip achieve the integrated and reconfigurable large-scale optical matrix operation using the single layer has become an urgent technical problem to be solved.

The following provides a detailed description of the present disclosure in combination with specific examples.

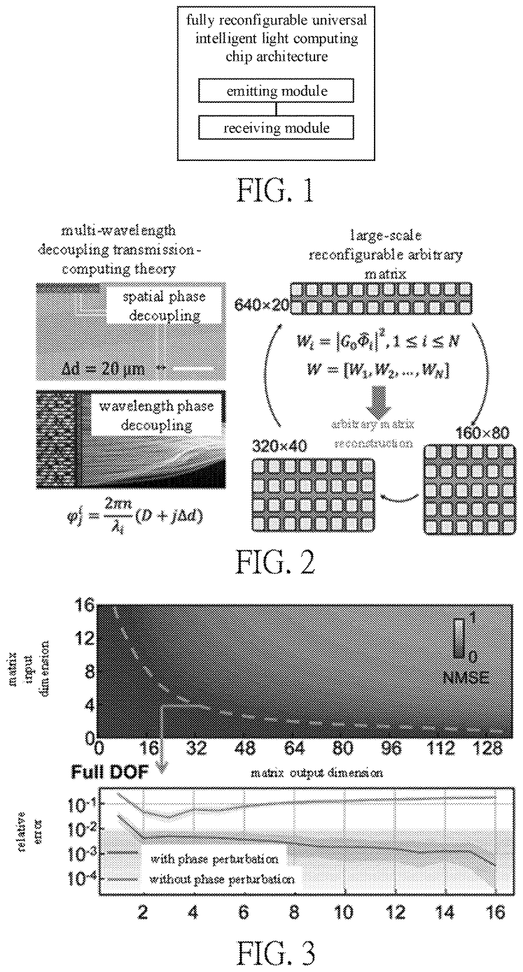

FIG. 1 is a block diagram of an architecture of a fully reconfigurable universal intelligent light computing chip according to the embodiments of the present disclosure. As shown in FIG. 1, the architecture of the fully reconfigurable universal intelligent light computing chip includes:
an emitting module, configured to obtain and emit at least one set of single-wavelength beam-split lights by splitting each first single-wavelength light in a first broadband light corresponding to a target task into beams; and
a receiving module, configured to receive the at least one set of single-wavelength beam-split lights, and perform a matrix calculation on the at least one set of single-wavelength beam-split lights based on an optical propagation matrix corresponding to the target task to obtain a second broadband light subjected to optical computation.

According to some embodiments, a high-speed signal corresponding to the target task may be loaded into a broadband spectrum to obtain the first broadband light, and the first broadband light may be multiplexed in the emitting module.

In some embodiments, there is a one-to-one correspondence between the first single-wavelength light and the set of single-wavelength beam-split lights. In the emitting module, each type of the first single-wavelength light in the first broadband light input needs to be transmitted on a same waveguide and emitted for diffraction, so that one waveguide is split into a plurality of waveguides and the set of single-wavelength beam-split lights composed of a plurality of single-wavelength beam-split lights is obtained. In a process of beam splitting, beams may be divided equally or not, and a specific adjustment may be made according to an application scenario.

According to some embodiments, the second broadband light includes at least one second single-wavelength light, and there is a one-to-one correspondence between the second single-wavelength light and the first single-wavelength light. The “first” in the first broadband light, the second broadband light, the first single-wavelength light, and the second single-wavelength light, and the “second” in a second integrated communication-computing conversion chip, have no special meaning and are only used for differentiation.

In some embodiments, there is a one-to-one correspondence between the set of single-wavelength beam-split lights and a row in the optical propagation matrix, and there is a one-to-one correspondence between a single-wavelength beam-split light in the set of single-wavelength beam-split lights and a row element in the row. That is to say, when performing a matrix calculation on the at least one set of single-wavelength beam-split lights based on an optical propagation matrix corresponding to the target task, an optical calculation is performed on the single-wavelength beam-split light in the set of single-wavelength beam-split lights and a corresponding row element.

It is easy to understand that when the architecture performs the matrix calculation on the at least one set of single wavelength split beams based on the optical propagation matrix corresponding to the target task, the architecture performs the optical calculation on the single-wavelength beam-split light in the set of single-wavelength beam-split lights and the corresponding row element, which may overcome a contradiction between reconfiguration and scale integration, and achieve the integrated and reconfigurable large-scale optical matrix operation using the single layer.

Optionally, in which the emitting module, when obtaining the at least one set of single-wavelength beam-split lights by splitting each first single-wavelength light in the first broadband light corresponding to the target task into the beams, is specifically configured to:
obtain at least one initial set of single-wavelength beam-split lights by splitting each first single-wavelength light in the first broadband light corresponding to the target task into the beams; and
obtain the at least one set of single-wavelength beam-split lights by modulating the at least one initial set of single-wavelength beam-split lights based on the target task.

According to some embodiments, when modulating the at least one initial set of single-wavelength beam-split lights based on the target task, the emitting module may perform phase modulation on the at least one initial set of single-wavelength beam-split lights based on the target task.

In some embodiments, the phase modulation may be performed on the at least one initial set of single-wavelength beam-split lights using an application specific integrated circuit (ASIC) interface.

In some embodiments, the phase modulation of the initial set of single-wavelength beam-split lights may be achieved by driving the ASIC interface via electrode leads using a voltage source.

Optionally, the emitting module, when emitting the at least one set of single-wavelength beam-split lights, is specifically configured to: emit the at least one set of single-wavelength beam-split lights via an emitting grating.

According to some embodiments, the set of single-wavelength beam-split lights may be emitted from a grating end of a corresponding emitting grating and received by a receiving module of a next stage.

Optionally, before performing the matrix calculation on the at least one set of single-wavelength beam-split lights based on the optical propagation matrix corresponding to the target task, the receiving module is further configured to:
determine a number of wavelengths corresponding to the first single-wavelength light in the target task and a number of split beams corresponding to the set of single-wavelength beam-split lights;
construct an initial optical propagation matrix by taking the number of wavelengths as a number of rows and the number of split beams as a number of columns; and
obtain the optical propagation matrix corresponding to the target task by determining a value of each element in the initial optical propagation matrix based on the target task.

It needs to be noted that FIG. 2 is a schematic diagram of a principle of an architecture of a fully reconfigurable universal intelligent light computing chip according to the embodiments of the present disclosure. As shown in FIG. 2, element values of a traditional light computing matrix architecture are very close when wavelength intervals are similar, and thus matrix column vectors are highly linearly correlated, which leads to a small matrix rank implemented by a chip. A multi-wavelength decoupling theory originates from two parts: decoupling of different wavelengths on a shared waveguide of the chip and spatial phase decoupling of waveguides at different spatial positions. For a single emitting waveguide, a propagation distance on the waveguide from inputting a light to emitting the light is d>>~1.5 μm.

This distance causes random phase decoupling of different wavelengths at emission, as a phase difference between wavelengths λᵢ and λₖ after a propagation may be described as

$$δ {φ}_{1} = \frac{d}{{λ}_{i}} - \frac{d}{{λ}_{k}} \approx \frac{d}{λ} \frac{δ λ}{λ} ≫ π .$$

A long waveguide amplifies an originally small phase difference, resulting in inconsistent initial emission phases for different wavelengths in a single waveguide. For lights emitted from different positions, after a previous emitting grating, a waveguide light is further subjected to a phase modulation δφ₂ by the waveguide, which responds to different wavelengths, so that for an emitting light across an entire emitting surface (assuming there are 256 emitting gratings), corresponding propagation matrices for different wavelengths of light are highly nonlinearly correlated, thereby providing theoretical and architectural support for implementing an arbitrary matrix in the single layer.

In some embodiments, as shown in FIG. 2, existing light computing is only reconfigurable trainable parameters, with a fixed and non-reconfigurable architecture. Meanwhile, only a 4×4 computational scale may be realized under a condition that there is a finite chip area. Under an effective multi-wavelength phase perturbation condition in the waveguide, the architecture in the embodiment may realize that a matrix input Dᵢₙ and output Dₒᵤₜ satisfies Dᵢₙ×Dₒᵤₜ≤DoF, and the invention may achieve a matrix implementation of any dimensional input and output under a full degree-of-freedom (DoF) constraint. An input dimension depends on a number of input wavelengths and the wavelength interval is required to meet a minimum perturbation standard δλ≥δλₘᵢₙ, while an output dimension may be adaptively adjusted by changing a number of receiving positions. That is to say, the architecture in the embodiment may realize universal intelligent light computing that arbitrary matrix architecture and parameter may be reconfigured. For example, arbitrary matrix operation used with the full DoF, such as 640×20, 320×40, 160×80, may be implemented.

In some embodiments, FIG. 3 is a schematic diagram of a simulation result of an architecture of a fully reconfigurable universal intelligent light computing chip according to the embodiments of the present disclosure. As shown in FIG. 3, it demonstrates that a relative error of an implemented matrix is significantly reduced under a chip phase perturbation compared to a condition without phase perturbation. Simulations and experiments show that a relationship between an input-output DoF of the arbitrary matrix and a matrix implementation accuracy, as illustrated in FIG. 3. A boundary function between a high accuracy and a low accuracy may be expressed as Dᵢₙ×Dₒᵤₜ=DoF, with all parts below the function representing an effective high-precision matrix implementation.

According to some embodiments, when determining the value of the each element in the initial optical propagation matrix based on the target task, the receiving module is configured to train the value of the each element in the initial optical propagation matrix based on the target task.

In some embodiments, the value of the element corresponds to a response value of an associated single-wavelength beam-split light under a unit intensity. The value may also be determined by a following equation:

$${W}_{i} = {\vert {G}_{0 i} {\hat{Φ}}_{i} \vert}^{2} , 1 \leq i \leq N$$

The set of single-wavelength beam-split lights includes N single-wavelength beam-split lights, where N is a positive integer greater than 1. Wi represents a value of an element corresponding to the i-th single-wavelength beam-split light in the set of single-wavelength beam-split lights. G₀ᵢ represents a propagation matrix of the i-th single-wavelength beam-split light in the set of single-wavelength beam-split lights, and \hat{Φ}ᵢ represents an optical propagation parameter associated with the i-th single-wavelength beam-split light in the set of single-wavelength beam-split lights.

It is readily understood that by designing a waveguide interval spectral perturbation on the chip and jointly modeling a space and a frequency spectrum of light at an input end, a fully reconfigurable spatially arbitrary-dimensional diffraction computational model for light computing chips may be constructed. This enables a single-layer light computing chip of a matrix in any shape with a full DoF, which overcomes a contradiction between reconfiguration and scale integration.

Optionally, the receiving module, when performing the matrix calculation on the at least one set of single-wavelength beam-split lights based on the optical propagation matrix corresponding to the target task, the receiving module is specifically configured to:
perform a matrix multiplication operation with the optical propagation matrix by taking a light intensity corresponding to each single-wavelength beam-split light in the at least one set of single-wavelength beam-split lights as an input.

For example, in a scenario where the first broadband light only includes one first single-wavelength light, which is split into N single-wavelength beam-split lights, an input of the optical propagation matrix may be expressed as:

$$X = {[ {x}_{1} , … , {x}_{N} ]}^{T}$$

x represents a light intensity of a single-wavelength beam-split light.

The optical propagation matrix corresponding to the first single-wavelength light may be expressed as:

$$W = [ {W}_{1} , {W}_{2} , … , {W}_{N} ]$$

Subsequently, a second single-wavelength light obtained after a matrix multiplication of X and W may be expressed as:

$$Y = {x}_{1} {W}_{1} + {x}_{2} {W}_{2} + … + {x}_{N} {W}_{N}$$

According to some embodiments, after performing the matrix multiplication to obtain x₁W₁, x₂W₂ . . . xᵢWᵢ, an entire matrix computation is completed by summing these them via an incoherent superposition.

In summary, the architecture in the embodiment, supported by the multi-wavelength decoupling theory, achieves phase decoupling on the chip via a waveguide perturbation by using wavelength information of an optical field, which achieves the spatial phase decoupling, maximizes the DoF of the modulation, realizes fully universal reconfigurable matrix computing approaching a matrix calculation upper limit capability theoretically, significantly expands an application scope of photonic computing, and lays a solid foundation for light computing of an artificial intelligence (AI) large model, promises new opportunities for high-performance AI large-model computing in the post-Moore era, and enables on-chip deployment of the light chip of the AI large model.

In order to implement above embodiments, the present disclosure also provides a system of a fully reconfigurable universal intelligent light computing chip, including: architectures of a plurality of fully reconfigurable universal intelligent light computing chips.

Optionally, the system includes: the architectures of the plurality of fully reconfigurable universal intelligent light computing chips. A connection way in the architectures of the plurality of fully reconfigurable universal intelligent light computing chips includes at least one of:
a series connection; or
a parallel connection.

In a technical solution of the present disclosure, processing including collection, storage, use, shaping, transmission, provision and disclosure of the user's personal information is in compliance with the provisions of relevant laws and regulations, and do not violate public order and moral.

It needs to be noted that personal information from users should be collected for a legitimate and reasonable purpose, and should not be shared or sold beyond these legitimate uses. In addition, such collection/sharing should be carried out after receiving an informed consent from the user, including but not limited to, notifying the user to read a user agreement/user notification and sign an agreement/authorization that includes an authorization of relevant user information before using this function. In addition, necessary steps should be taken to safeguard an access to such personal information data, and to ensure that others who have the right to access the personal information data comply with a privacy policy and procedures.

The present disclosure is expected to provide an implementation plan for the user to selectively block the use or access of the personal information data, that is, the present disclosure is intended to provide hardware and/or software to prevent or block access to the personal information data. Once the personal information data is no longer needed, limiting data collection and deleting data may minimize risks. In addition, when applicable, a personal identifier should be removed from the personal information to protect a privacy of the user.

Acquisition, transmission, storage, use, and processing of data in the technical solution of the present disclosure comply with relevant regulations in national laws.

It needs to be noted that in the embodiments of the present disclosure, some software, components, models, and other existing solutions in the industry may be mentioned, which should be considered as exemplary. The purpose is only to illustrate a feasibility of the technical solution in the application, but it does not mean that the applicant has already or necessarily used the solution.

In the description of the present disclosure, reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. The appearances of the phrases in various places throughout this specification are not necessarily referring to the same embodiment or example of the present disclosure. Furthermore, the particular features, structures, materials, or characteristics may be combined in any suitable manner in one or more embodiments or examples. In addition, without a contradiction, the different embodiments or examples and the features of the different embodiments or examples in the specification may be combined by those skilled in the art.

In addition, terms such as “first” and “second” are used herein for purposes of description and are not intended to indicate or imply relative importance or implicitly indicate the number of indicated technical features. Furthermore, the feature defined with “first” and “second” may include one or more this feature distinctly or implicitly. In the description of the present disclosure, “a plurality of” means at least two, such as two, three, unless specified otherwise.

Any procedure or method described in the flow charts or described in any other way herein may be understood include one or more modules, portions or parts for executing instruction codes that implement steps of a custom logic function or procedure. And preferable embodiments of the present disclosure include other implementation, in which the order of execution is different from what is depicted or discussed, including executing functions in a substantially simultaneous manner or in an opposite order according to the related functions, which may be understood by the skilled in the art of embodiments of the present disclosure.

The logic and/or step described in other manners herein or shown in the flow chart, for example, a particular sequence table of executable instructions for realizing the logical function, may be specifically achieved in any computer readable medium to be used by the instruction execution system, device or equipment (such as a system based on computers, a system including processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples (non-exhaustive list) of the computer readable medium include but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It may be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

The skilled in the art may understand that implementing all or a part of steps carried by the method of the above embodiments may be completed by a program indicating the related hardware. The program may be stored in a computer readable storage medium. The program includes one of the embodiments of the method or the combination thereof when being executed.

In addition, respective function units in respective embodiments of the present disclosure may be integrated in one processing unit, or each unit may also exist physically alone, or two or more units may be integrated in one unit. The foregoing integrated unit may be implemented either in hardware or software functional units. If the integrated unit is implemented as a software functional unit and is sold or used as a stand-alone product, it may be stored in a computer readable storage medium.

The above mentioned storage medium may be a ROM, a disk or a disc. Although embodiments of the present disclosure have been shown and described above, it may be understood that, the above embodiments are exemplary, and may not be understood to limit the present disclosure. Those skilled in the art may make changes, alternatives, and modifications in the above embodiments within scope of the present disclosure.

What is claimed is:

1. An architecture of a fully reconfigurable universal intelligent light computing chip, comprising:
an emitting module, configured to obtain and emit at least one set of single-wavelength beam-split lights by splitting each first single-wavelength light in a first broadband light corresponding to a target task into beams, wherein there is a one-to-one correspondence between the first single-wavelength light and the set of single-wavelength beam-split lights; and
a receiving module, configured to receive the at least one set of single-wavelength beam-split lights, and perform a matrix calculation on the at least one set of single-wavelength beam-split lights based on an optical propagation matrix corresponding to the target task to obtain a second broadband light subjected to optical computation, wherein the second broadband light comprises at least one second single-wavelength light, there is a one-to-one correspondence between the second single-wavelength light and the first single-wavelength light, there is a one-to-one correspondence between the set of single-wavelength beam-split lights and a row in the optical propagation matrix, and there is a one-to-one correspondence between a single-wavelength beam-split light in the set of single-wavelength beam-split lights and a row element in the row.

2. The architecture of claim 1, wherein the emitting module, when obtaining the at least one set of single-wavelength beam-split lights by splitting each first single-wavelength light in the first broadband light corresponding to the target task into the beams, is specifically configured to:
obtain at least one initial set of single-wavelength beam-split lights by splitting each first single-wavelength light in the first broadband light corresponding to the target task into the beams; and
obtain the at least one set of single-wavelength beam-split lights by modulating the at least one initial set of single-wavelength beam-split lights based on the target task.

3. The architecture of claim 2, wherein the emitting module, when modulating the at least one initial set of single-wavelength beam-split lights based on the target task, is specifically configured to:
perform phase modulation on the at least one initial set of single-wavelength beam-split lights based on the target task.

4. The architecture of claim 1, wherein before performing the matrix calculation on the at least one set of single-wavelength beam-split lights based on the optical propagation matrix corresponding to the target task, the receiving module is further configured to:
determine a number of wavelengths corresponding to the first single-wavelength light in the target task and a number of split beams corresponding to the set of single-wavelength beam-split lights;
construct an initial optical propagation matrix by taking the number of wavelengths as a number of rows and the number of split beams as a number of columns; and
obtain the optical propagation matrix corresponding to the target task by determining a value of each element in the initial optical propagation matrix based on the target task.

5. The architecture of claim 4, wherein the receiving module, when determining the value of the each element in the initial optical propagation matrix based on the target task, is specifically configured to:
train the value of the each element in the initial optical propagation matrix based on the target task.

6. The architecture of claim 1, wherein the receiving module, when performing the matrix calculation on the at least one set of single-wavelength beam-split lights based on the optical propagation matrix corresponding to the target task, is specifically configured to:
perform a matrix multiplication operation with the optical propagation matrix by taking a light intensity corresponding to each single-wavelength beam-split light in the at least one set of single-wavelength beam-split lights as an input.

7. The architecture of claim 1, wherein the emitting module, when emitting the at least one set of single-wavelength beam-split lights, is specifically configured to:
emit the at least one set of single-wavelength beam-split lights via an emitting grating.

8. A system of a fully reconfigurable universal intelligent light computing chip, comprising: an architecture of at least one fully reconfigurable universal intelligent light computing chip of claim 1.

9. The system of claim 8, comprising: architectures of a plurality of fully reconfigurable universal intelligent light computing chips.

10. The system of claim 9, wherein a connection way in the architectures of the plurality of fully reconfigurable universal intelligent light computing chips comprises at least one of:
a series connection; or
a parallel connection.
